(19) United States
(12) Patent Application Publication
(10) Pub. No.: US 2009/0317034 A1
(43) Pub. Date: Dec. 24, 2009

(54) Optical pulse time spreading device for spreading light pulse over time axis

(75) Inventors: Kensuke Sasaki, Kanagawa (JP); Shuko Kobayashi, Kanagawa (JP)

Correspondence Address: RABIN & Berdo, PC, 1101 14TH STREET, NW, SUITE 500, WASHINGTON, DC, 20005, US

(73) Assignee: OKI ELECTRIC INDUSTRY CO., LTD., Tokyo (JP)

(21) Appl. No.: 12/457,681

(22) Filed: Jun. 18, 2009

(30) Foreign Application Priority Data
Jun. 19, 2008 (JP) 2008-160265

(51) Int. Cl. G02B 6/34

(52) U.S. Cl. 385/37

(57) ABSTRACT

An optical pulse time spreading device includes an optical fiber and a superstructured fiber Bragg grating (SSFBG) formed in the optical fiber. The SSFBG includes unit fiber Bragg gratings (FBGs) having the effective refractive index of the optical fiber periodically varying in the longitudinal direction of the fiber, and phase shifters having a constant effective refractive index. Each unit FBG is arranged between the adjacent phase shifters in the longitudinal direction. The unit FBG having its unit grating length in the longitudinal direction shorter than the unit segment length which is the distance between the unit FBGs next to each other. The optical pulse time spreading device provides the peak intensity of the autocorrelation wave less dependent on a code used for encoding and decoding.

### BACKGROUND OF THE INVENTION

1. Field of the Invention

The present invention relates to an optical pulse time spreading device for use in optical multiplex transmission, and more particularly to an optical pulse time spreading device making use of a superstructured fiber Bragg grating (SSFBG) having a plurality of unit gratings arranged, each of which is a structural unit in which effective refractive index is periodically varied therein, in the direction of propagating optical waves in an optical fiber.

2. Description of the Background Art

In response to recent rapid expansion of communication needs, promoted by dissemination of the Internet, high-speed, large-capacity networks making use of optical fiber have been constructed. In order to expand the capacity of transmission, a greater attention has been paid on optical multiplexing technique, by which a plurality of channels of light pulse signals are transmitted en bloc on a single optical fiber transmission path.

Optical time division multiplexing (OTDM), wavelength division multiplexing (WDM) and optical code division multiplexing (OCDM) have extensively been investigated as the optical multiplexing technique.

Among these, the OCDM is characterized by its flexibility in practical operation since there is no limitation on the number of light pulse signals allocatable to one bit over the time axis. It is also characterized in that a plurality of channels may be set to the same time slot on the time axis, or in that a plurality of communication channels may be set to the same wavelength also on the wavelength axis.

The OCDM is a sort of communication method, allocating different codes (patterns) to the individual channels, and extracting signals based on pattern matching, see H. Sotobayashi, “Optical Code Division Multiplexing Network”, Applied Physics, Vol. 71, No. 7, pp. 853-859, 2002, for example. Specifically, the OCDM is referred to as an optical multiplexing technique, encoding light pulse signals with codes, different between communication channels, at the transmitter end, and decoding the signals at the receiver end by using the same codes as used at the transmitter end, to thereby recover the original light pulse signals.

According to the OCDM, only light pulse signals matched to the code used for encoding may be extracted and processed as valid signals in the process of decoding, so that light pulse signals, resultant from combining lights of the same wavelength or a plurality of wavelengths, may be allocated to a plurality of communication channels. Decoding in OCDM at the receiver end requires the same codes as used for encoding, so that the signals cannot be decoded unless the codes are known. The OCDM is, therefore, understood as a transmission method excellent in information security.

The OCDM has attracted much attention for its potential of large-capacity data communication, because the OCDM is capable of multiplexing a plurality of channels at the same wavelength at the same point of time, and may therefore dramatically increase communication capacity as compared with the OTDM and WDM.

As exemplary methods of OCDM communication, there are known methods of OCDM communication using a binary phase code, see A. Nishiki, et al., “Development of Encoder/Decoder for OCDM using a SSFBG”, Technical Report of the Institute of Electronics Information and Communication Engineers, OFT2002-66, (November 2002), and N. Wada, et al., “A 10 Gb/s Optical Code Division Multiplexing Using 8-Chip Optical Bipolar Code and Coherent Detection”, Journal of Lightwave Technology, Vol. 17, No. 10, October 1999, for example. There have recently been known also methods of OCDM communication using a multi-valued phase code, see P. C. Teh, et al., “Demonstration of a Four-Channel WDM/OCDMA System Using 255-Chip 320-Gchip/s Quaternary Phase Coding Gratings”, IEEE Photonics Technology Letters, Vol. 14, No. 2, February 2002, and Gabriella Cincotti, “Full Optical Encoders/Decoders for Photonic IP Routers”, Journal of Lightwave Technology, Vol. 22, No. 2, pp. 337-342, February 2004, for example. The binary phase code or the multi-valued phase code may simply be referred to as “phase code”, hereinafter.

The method of OCDM communication using the phase code may be implemented through the following steps. First, the output of a multi-wavelength continuous-light source is modulated into a light pulse train on the transmitter end, and then the light pulse train is used to produce signals to be transmitted, which are binary digital signals, in the form of light pulse signals of an RZ (return to zero) format. The light pulse signals having the RZ format may hereinafter simply be referred to as “light pulse signals”.

At the transmitter end, light pulse signals to be transmitted are encoded by an encoder, and resultant encoded light pulse signals are transmitted. On the other hand, at the receiver end, the encoded light pulse signals are received and then decoded by a decoder having the same code set as the encoder to thereby restore the transmitted light pulse signals.

In the OCDM communication method using phase codes, light pulse signals are spread over the time axis according to a certain rule set to an encoder to be thereby encoded into encoded light pulse signals. Such a certain rule in this case is specified by a code. Light pulses carrying encoded light pulse signals resultant from spreading light pulse signals over the time axis may simply be referred to as “chip pulses”, hereinafter. In other words, the encoder functions to spread individual light pulses carrying light pulse signals over the time axis in order to produce a chip pulse train.

On the other hand, the encoded light pulse signals are decoded by a decoder into the original light pulse signals. More specifically, the decoder recovers, from a chip pulse train carrying encoded light pulse signals, individual light pulses carrying an original light pulse signal to thereby the original light pulse signals.

The SSFBG-based encoder and decoder have the same SSFBG in structure as each other. Therefore in the description hereinafter, such an encoder and a decoder may en bloc be covered by a more general term “optical pulse time spreading device”. More specifically, the role of the encoder and the decoder used in an OCDM communication system is dependent upon locations in the system where they are disposed. Therefore, the optical pulse time spreading device may function as an encoder when disposed at a transmitter end, and may function as a decoder when disposed at a receiver end.

The fiber Bragg grating (FBG) is an optical fiber having Bragg gratings formed in the core thereof, each of which being periodically modulated ineffective refractive index, and functions as a filter which reflects light of a specific wavelength corresponding to the periodicity set thereon, see the above-mentioned Nishiki et al., and P. C. Teh et al., for instance. The FBG is configured merely by periodically modulating the effective refractive index of the core of optical fiber, while leaving the geometry thereof unchanged from that of any optical fibers used for optical transmission path of optical communication based on the OCDM. Accordingly, if the FBG is used as a constitutive element of optical communication devices, the devices may be connectable with an optical transmission path by directly applying general techniques of mutually connecting optical fibers.

In the SSFBG applicable to the encoder and decoder, a phase shifter is provided between every adjacent unit FBGs. The amount of phase shift set to the phase shifter may be determined by a code set to the encoder and the decoder. For example, an SSFBG having a plurality (S) of unit FBGs will have the phase shifters provided at the number of (S-1) positions, wherein the code set to the SSFBG is determined by the amount of phase shift set to each of the (S-1) positions.

Besides the above-described SSFBG, also a PLC (Planar Lightwave Circuit) having a transversal-type filter structure may be applied to the encoder and the decoder, see the above-mentioned Naoya Wada, et al., for example. Also an AWG (Array Waveguide Gratings) is applicable, see Jing Cao, et al., “Spectral Encoding and Decoding of Monolithic InP OCDMA Encoder”, Paper We. 3.6.6, Vol. 3, ECOC 2005, for example. The encoder and decoder, using the PLC and AWG, are characterized in that there are no limitations on the codes settable thereto. However, they are inferior to those using the SSFBG because of the larger loss of light and the difficulty in downsizing of the device. Therefore, use of the SSFBG for the optical encoder adapted to the OCDM transceiver system has attracted a public attention.

However, a problem resides in the receiver end of the OCDM transceiver system, in that the energy ratio of autocorrelation wave components to cross-correlation wave components, which are obtained by receiving an OCDM signal produced from the synthesis of encoded signals on the individual channels, and by decoding the OCDM signal, depends on a code used for encoding. Since the autocorrelation wave components are signal components and the cross-correlation wave components are noise, the energy ratio of the autocorrelation wave components to the cross-correlation wave components corresponds to the so-called signal-to-noise (S/N) ratio of a received signal. Since the S/N ratio decreases as the number of multiplexed channels in the OCDM transceiver system increases, it has conventionally been necessary for the receiver end to take some special measure, such as implementing time gate processing for discriminating the autocorrelation wave from the cross-correlation wave, or using an expensive non-linear device as disclosed in Wei Cong, et al., “An Error-Free 100 Gb/s Time Slotted SPECTS O-CDMA Network Testbed”, Paper Th.1.4.6, Vol. 3, 2005.

### SUMMARY OF THE INVENTION

It is therefore an object of the present invention to provide an optical pulse time spreading device capable of making the energy ratio of the autocorrelation wave components to the cross-correlation wave components less dependent on a code used for encoding, and making the energy ratio larger than conventional optical pulse time spreading devices.

In the course of investigations into the optical pulse time spreading device configured by using the SSFBG, aiming at achieving the above-described object of the invention, the inventors found out that the above-described problems may be solved by properly adjusting a relation between the length of each unit FBG forming an SSFBG and the distance of every adjacent unit FBGs. In other words, the inventors finally found out that critical is the ratio of a unit grating length and a unit segment length, capable of making the energy ratio of the autocorrelation wave components to the cross-correlation wave components less dependent on a code used for encoding and making the energy ratio larger.

In the context, the unit grating length means the length of a unit FBG, and the unit segment length means the distance of arrangement of every adjacent unit FBGs. Note that the energy ratio of the autocorrelation wave components to the cross-correlation wave components may simply be referred to as “S/N ratio”.

In accordance with the present invention, an optical pulse time spreading device includes an optical fiber and a super structured fiber Bragg grating (SSFBG) formed in the optical fiber. The SSFBG further includes a plurality of unit fiber Bragg gratings (FBGs) having the effective refractive index of the optical fiber periodically varying, and phase shifters having a constant effective refractive index. Each of the unit FBGs is arranged between the phase shifters in the longitudinal direction. The unit FBG has its unit grating length in the longitudinal direction shorter than the unit segment length which represents the distance between the unit FBGs next to each other.

According to an optical pulse time spreading device of the present invention, chip pulses produced as a result of Bragg reflection respectively by the adjacent unit FBGs may be reduced in components possibly overlapped with each other on the time axis. As a consequence, a chip pulse train produced by the optical pulse time spreading device from one of the input light pulses may be decoded by an optical pulse time spreading device having the same structure as the above-described device to be reproduced in the form of light pulse having a pronounced peak intensity on the time axis.

Furthermore, according to an optical pulse time spreading device of the present invention, the peak intensity of the autocorrelation wave is less dependent upon a code used for encoding and decoding.

### BRIEF DESCRIPTION OF THE DRAWINGS

The objects and features of the present invention will become more apparent from consideration of the following detailed description taken in conjunction with the accompanying drawings in which:

FIG. 1A is a schematic sectional view of an SSFBG used for an optical pulse time spreading device according to one embodiment of the present invention;

FIG. 1B schematically illustrates a modulation structure of the effective refractive index;

FIG. 1C is a partially enlarged view of the modulation structure of the effective refractive index;

FIG. 2 schematically shows, for the purpose of understanding the principle of operation of the embodiment provided with a pair of the SSFBGs having an identical built-in periodical structure of refractive index;

FIG. 3A plots temporal waveforms of chip pulse trains obtained by Bragg reflection from unit FBGs in a receiver end in FIG. 2;

FIG. 3B plots a temporal waveform of an autocorrelation wave of an input light pulse generated by SSFBGs in the receiver end;

FIG. 4 schematically shows, like FIG. 2, for the purpose of understanding the principle of operation of an alternative embodiment provided with a pair of the SSFBGs having a different built-in periodical structure of refractive index;

FIG. 5A plots, like FIG. 3A, temporal waveforms of chip pulse trains obtained by Bragg reflection from unit FBGs in a receiver end in FIG. 4;

FIG. 5B plots, like FIG. 3B, a temporal waveform of a cross-correlation wave of an input light pulse generated by SSFBGs in the receiver end shown in FIG. 4;

FIG. 6A schematically illustrates a light pulse input to an SSFBG included in an encoder for the purpose of understanding interference between chip pulses produced by the adjacent unit FBGs;

FIG. 6B independently plots temporal waveforms of chip pulses produced by the adjacent unit FBGs shown in FIG. 6A;

FIG. 6C plots temporal waveforms of chip pulse trains obtained from a case where the relative phase of a chip pulse and that of another chip pulse differ from each other by Π radian; and

FIG. 6D plots temporal waveforms of chip pulse trains obtained from a case where the two chip pulses are in phase with respect to each other;

FIG. 7A schematically illustrates a light pulse input to an SSFBG included in an encoder for the purpose of understanding effects of the S/N ratio of autocorrelation wave components to cross-correlation wave components;

FIG. 7B plots temporal waveforms of Bragg-reflected light components reflected at both ends and equally-spaced points of the unit FBG in FIG. 7A; and

FIG. 7C plots temporal waveforms of Bragg-reflected light obtained from the unit FBG in FIG. 7A;

FIGS. 8A through 11B plot results of a simulation for investigating code dependence of the energy ratio of autocorrelation wave components to cross-correlation wave components, with respect to various relations between the unit grating length and the unit segment length of an SSFBG; and

FIG. 12 is a graph useful for understanding code dependence of the energy ratio of autocorrelation wave components to cross-correlation wave components, in relation to the ratio of the unit grating length and the unit segment length.

### DESCRIPTION OF THE PREFERRED EMBODIMENTS

Preferred embodiments in accordance with the present invention will be described below with reference to the accompanying drawings, wherein the embodiments of the present invention are by no means limited by what are specifically shown in the drawings. Note also that any specific conditions applied in the description below are none other than mere preferred exemplifications, and never limits the embodiments.

The optical pulse time spreading device of the present invention may mainly be implemented as an encoder and a decoder of an optical multiplex signal transceiver system. In illustrating structures and operations of the optical pulse time spreading device of the present invention, the structure of a superstructured fiber Bragg grating (SSFBG) included in the optical pulse time spreading device will be described first according to one embodiment of the present invention.

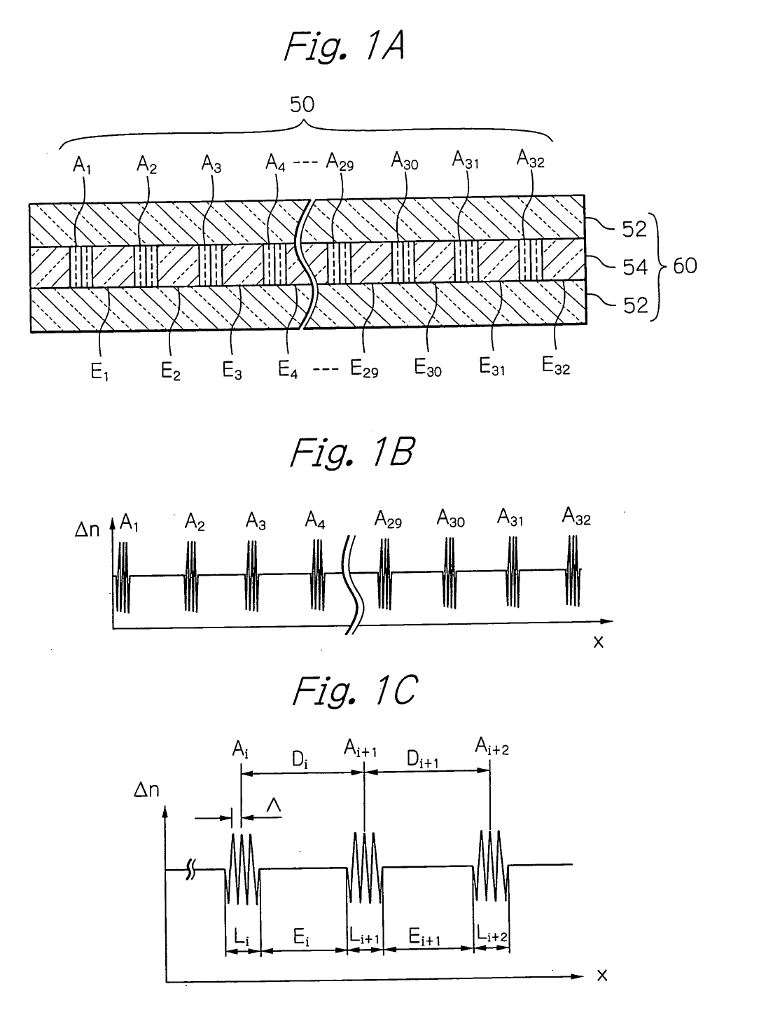

A schematic structure of an SSFBG used for the optical pulse time spreading device according to one embodiment of the present invention will be described, referring to FIGS. 1A, 1B and 1C. FIG. 1A is a schematic sectional view of an SSFBG 50. The SSFBG 50 is configured such as to be incorporated into a core 54 forming an optical fiber 60 having its cross section generally circular together with a clad 52 enclosing the periphery of the core 54 and extending the longitudinal direction of the fiber 60. Both the core 54 and the clad 52 are made from material having high optical transmissivity. However, the refractive index of the core 54 is higher than that of the clad 52.

In the SSFBG 50 illustrated in FIG. 1, thirty-two unit FBGs are serially arranged in the direction of propagating optical wave, i.e. one of the longitudinal directions, of the core 54 which serves as a waveguide in the optical fiber 60. The first to the 32nd FBGs are specified with sequential symbols from A₁ to A₃₂, respectively. Further, between every adjacent unit FBGs, more specifically between the Aᵢ-th unit FBG denoted by Aᵢ and the Aᵢ₊₁-th unit FBG denoted by Aᵢ₊₁, where i is a natural number from 1 to 31, inclusive, there is provided in the core 54 a phase shifter Eᵢ having its effective refractive index not modulated therein. In FIG. 1, the first to the 32nd shifters are designated with sequential symbols from E₁ to E₃₂, respectively.

The unit FBGs in the illustrative embodiments are formed as portions of the optical fiber 60 having the effective refractive index thereof periodically varying in the direction of propagating optical waves, or wave propagation direction, in the fiber 60. In other words, each of the unit FBGs occupies a continuous portion of the FBG, having its periodicity of modulation of effective refractive index not varying or its phase not shifted.

FIG. 1B schematically illustrates the modulation structure of the effective refractive index of the SSFBG 50 shown in FIG. 1A. The abscissa represents positional coordinate x in the longitudinal direction of the optical fiber 60 having the SSFBG 50 formed therein. The ordinate represents the effective refractive index of the optical fiber 60 as a modulation structure, wherein difference between the maximum and minimum values of the effective refractive index of the core 54 in the optical fiber 60 is denoted by Δn. FIG. 1C is a partially enlarged view of the modulation structure of the effective refractive index of the core 54 in the optical fiber 60.

The periodicity of modulation of effective refractive index is represented by a letter Λ. The wavelength λ of Bragg reflection is therefore given as λ=2N_{eff}Λ, where N_{eff} represents the effective refractive index of the optical fiber 60. A light pulse input to the SSFBG 50 having 32 unit FBGs is temporally spread to produce 32 chip pulses. The first to 32nd unit FBGs of the SSFBG 50, denoted by A₁ to A₃₂ from the left to the right end in FIGS. 1A and 1B, correspond one-by-one to the chip pulses output from the SSFBG 50.

As shown in FIG. 1C, between every adjacent unit FBGs, there is provided a phase shifter Eᵢ having the effective refractive index not modulated therein. The phase shifter Eᵢ is a portion having its effective refractive index of the optical fiber designed as constant in the direction of propagating optical waves in the optical fiber. By adjusting in design the length of a phase shifter in the wave propagation direction of the optical fiber, the relative phase difference of Bragg-reflected light impinging from the unit FBGs arranged adjacent to that phase shifter may appropriately be controlled.

The unit grating length, defined as the length of the Aᵢ-th unit FBG in the longitudinal direction of the optical fiber 60, or more specifically in the wave propagation direction of the optical fiber 60, is denoted by Lᵢ, where i is a natural number from 1 to 32, inclusive, in this context. The unit segment length, defined as the distance between the adjacent unit FBGs, or more specifically between the Aᵢ-th and the Aᵢ₊₁-th unit FBG, is denoted by Dᵢ. Thus, the relation Dᵢ=Lᵢ+Eᵢ holds.

Note that expression of “phase shifter Eᵢ” may be used not only as a symbol for identifying, but also as a parameter representing the length of, a specific, i-th phase shifter. The symbol Eᵢ will be used without specifically stating that whether it is an identifier or a parameter representing the length, so far as confusion would not arise. The same will apply also to the unit grating length Lᵢ and the unit segment length Dᵢ.

Next, it will be described how the unit segment length Dᵢ is set, defined as the distance between the Aᵢ-th unit FBG denoted by Aᵢ and the Aᵢ₊₁-th unit FBG denoted by Aᵢ₊₁. Note that the description below will deal with an exemplary case of SSFBG included in the optical pulse time spreading device of the illustrative embodiments, preferably applicable to an optical signal multiplex transceiver system having a plurality (N) of channels. However, the SSFBG of the present invention may not be restricted to the specific illustrative embodiments of the optical pulse time spreading device described below.

The unit segment length Dᵢ is defined as the distance or pitch between the center points, in the longitudinal direction of the optical fiber, of the Aᵢ-th unit FBG denoted by Aᵢ and the Aᵢ₊₁-th unit FBG denoted by Aᵢ₊₁.

The relative phases the Aᵢ-th unit FBG denoted by Aᵢ the Aᵢ₊₁-th unit FBG denoted by Aᵢ₊₁ have are now assumed as Pᵢ and Pᵢ₊₁, respectively. The phase difference dᵢ between the both herein is given as Pᵢ₊₁−Pᵢ. Assuming now the effective refractive index of a portion between the Aᵢ-th and the Aᵢ₊₁-th unit FBGs, i.e. phase shifter Eᵢ, as N_{eff}, then Dᵢ and dᵢ are expressed by the relation of Dᵢ=(M+dᵢ)λ/2, wherein M is an arbitrary integer, and λ satisfies the relation of λ=λ₀/N_{eff}, assuming the effective refractive index of light pulses in vacuum as λ₀. Using angular phase, (M+dᵢ)λ may be expressed as 2Π(M+dᵢ).

Hereinafter, N is an integer equal to or larger than 2, m is any integer from 0 to (N-1), inclusive, i is a parameter specifying the first to N-th unit FBGs and any integer from 1 to N, inclusive, and a parameter b is a real number satisfying 0≦b<1. When an optical pulse time spreading device in accordance with the subject invention is used in an N-channel multiple transmitter and receiver system, the first to N-th channels depending on the values of m, ranging from 0 to (N-1), are desirably assigned one to one. In such a case, the value of m indicates a private mark code for discriminating a specific channel.

When designing the N-channel optical pulse time spreading device of the illustrative embodiments so as to set the relative phase of the unit FBG arranged at the input/output end of the SSEBG 50 to zero with the adjacent unit FBG having its relative phase equal to 2Π[b+(m/N)] and the next adjacent unit FBG having its relative phase equal to 2Π[b+(m/N)]*2, the unit segment lengths may be set equal to D₁=[M+b+(m/N)]λ/2 and D₂=[M+{b+(m/N)}]*2*(λ/2). In the general expression, assuming now the first unit FBG arranged at the input/output end of the SSFBG 50 as the first place, the k-th unit FBG at the k-th place may have its relative phase equal to 2Π[b+(m/N)]*(k−1) if the unit segment length is set equal to Dₖ=[M+{b+(m/N)}]*(k−1)λ/2.

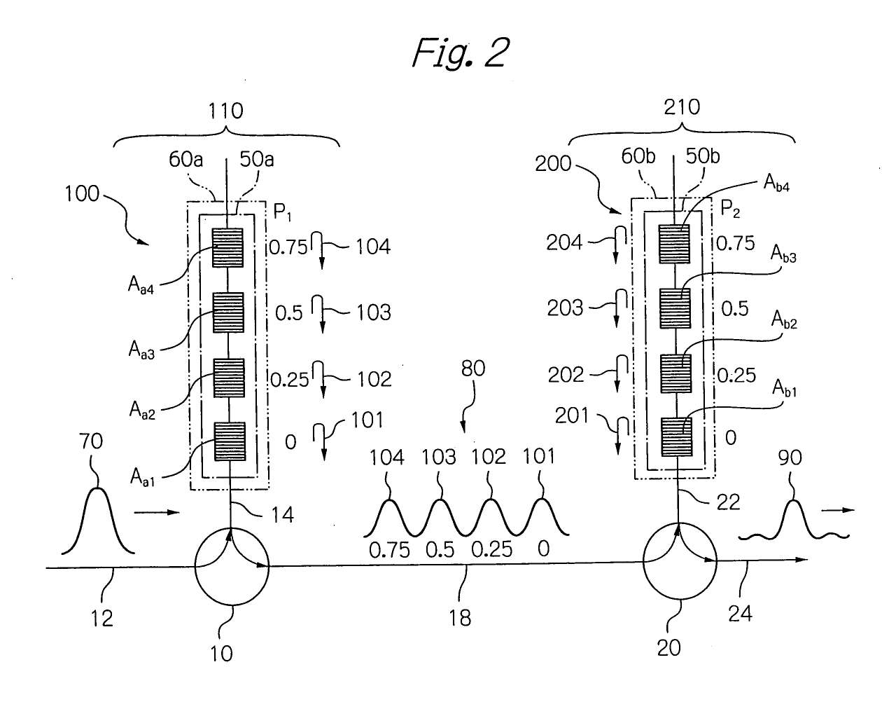

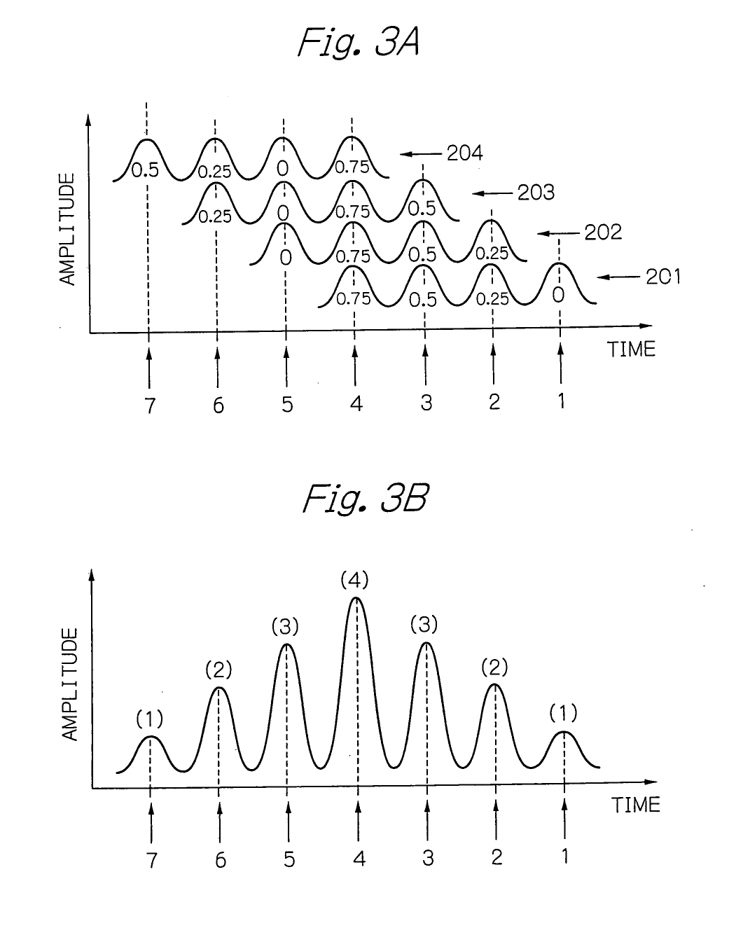

It will be described referring to FIGS. 2 and 3A and 3B how the optical pulse time spreading devices operate in principle, which are provided with a pair of SSFBGs having the built-in periodical structure of refractive index thereof identical to each other, when producing a chip pulse train and decoding a light pulse from the chip pulse train. Since all unit FBGs forming each SSFBG are the same in periodical structure of refractive index, all unit FBGs provide the same wavelength of Bragg reflection as each other.

FIG. 2 shows, for use in describing the principle of operation, a couple of optical fibers 60a and 60b having SSFBGs 50a and 50b, respectively, providing the structure and the function of the optical fiber 60 having the SSFBG 50. In the sender end 110 the SSFBG 50a is used while in the receiver end 210 the SSFBG 50b is applied.

FIG. 3A plots temporal waveforms of chip pulse trains 201, 202, 203 and 204 respectively obtained by Bragg reflection from unit FBGs A_{b1}, A_{b2}, A_{b3} and A_{b4}. The chip pulse trains 201, 202, 203 and 204 are obtained as a result of temporally spreading of the chip pulses 101, 102, 103 and 104 output from the SSFBG 50a, by the unit FBGs A_{b1}, A_{b2}, A_{b3} and A_{b4}. FIG. 3B plots a temporal waveform of an autocorrelation wave of an input light pulse, decoded by an SSFBG 50b.

FIG. 2 illustrates an exemplary case where one optical pulse time spreading devices having the SSFBGs 50a and 50b are used as a chip pulse converter 100 and a light pulse regenerator 200, respectively. A rule applicable to temporally spreading of the light pulse set to the SSFBGs 50a and 50b may be of a code in general. However, the applicable rule is not limited to a code system in a strict sense, so far as a single light pulse may be spread to produce a plurality of chip pulse trains over the time axis. The rule for temporally spreading of the light pulse set to the SSFBGs 50a and 50b is thus not of a code in a strict sense, but merely for the purpose of description the code is interpreted in a broader sense so that the chip pulse converter and regenerator may be referred to simply as an encoder 100 and as a decoder 200, respectively.

Although FIG. 2 illustrates one exemplary SSFBG having four unit FBGs, or an SSFBG with N=4, the description below regarding the principle of operation in producing the chip pulse train and regenerating the light pulse from the chip pulse train will also apply to any SSFBGs other than those of N=4, except for the number of chip pulses.

As shown in FIG. 2, the encoder 100 and the decoder 200 are connected to each other via an optical circulator 10, an optical fiber transmission path 18 and an optical circulator 20. The circulator 10 has a terminal 12 to which a light pulse 70 is input, another terminal 14 connected to the encoder 100 for outputting the light pulse 70 to the encoder 100 and receiving Bragg-reflected lights 101-104 generated by the encoder 100, and a further terminal 18 connected to the optical fiber transmission path 18 for outputting a chip pulse train 80 comprised of Bragg-reflected lights 101-104. Similarly, the circulator 20 has a terminal 18 to which the chip pulse train 80 is input, a terminal 22 connected to the decoder 200 for outputting the pulse train 80 to the decoder 200 and receiving an autocorrelation wave 90 generated by the decoder 200, and a terminal 24 for outputting the autocorrelation wave 90.

As illustrated in FIG. 2, an input light pulse 70 is routed through the optical circulator 10 to the SSFBG 50a for temporally spreading, and again routed through the optical circulator 10 to be output in the form of chip pulse train 80. The SSFBG 50a illustrated in FIG. 2 includes four unit FBGs Aₐ₁-Aₐ₄ arranged in the wave propagation direction in the optical fiber 60a. Accordingly, the number of chip pulses output from the SSFBG 50a and sequenced over the time axis is four.

When the light pulse 70 is input to the SSFBG 50a, Bragg-reflected lights 101, 102, 103 and 104 are produced by unit FBGs Aₐ₁, Aₐ₂, Aₐ₃ and Aₐ₄, respectively, and then output. Relative phases (P₁, FIG. 2) of the individual Bragg-reflected lights 101, 102, 103 and 104 are given as 0, 0.25, 0.5 and 0.75, respectively. The values of relative phase may be expressed in the form of sequence of (0, 0.25, 0.5, 0.75). The SSFBG 50b has the same periodical structure of effective refractive index as the SSFBG 50a.

In the exemplary SSFBG 50a shown in FIG. 2, the rule for temporally spreading a light pulse 70 set thereto corresponds to the case specified by m=0, N=4 and b=0.25, giving b+(m/N)=0.25. Accordingly, a sequence of relative phase values set to the unit FBGs included in the SSFBGs 50a and 50b may be given as (0, 0.25, 0.5, 0.75). Hereinafter, the term b+(m/N) may be referred to as the minimum unit of relative phase.

More specifically, since m=0, N=4 and b=0.25 are given, the chip pulse 101 at the head on the time axis will have its relative phase value equal to zero, and the chip pulse 102 at the head on the time axis will have its relative phase value equal to 2Π[b+(m/N)]=2Π×0.25, which is assumable as 0.25 after omitting 2Π. Similarly, the chip pulse 103 at the head on the time axis will have a value of 2Π[b+(m/N)]*2=2Π*0.25*2=2Π*0.5, which is assumable as 0.5 after omitting 2Π. Similarly, the chip pulse 104 at the head on the time axis will have a value of 2Π[b+(m/N)]*3=2Π*0.25*3=2Π*0.75, which is assumable as 0.75 after omitting 2Π. As a consequence, a sequence of relative phase values (P₂, FIG. 2) set to the unit FBGs forming the SSFBG 50b is given as (0, 0.25, 0.5, 0.75).

A chip pulse train 80 produced by the encoder 100 of the optical signal multiplex transceiver system may be reproduced as the light pulse 70 when decoded by the decoder 200 having the same structure as the encoder 100, wherein a light pulse output from the decoder and having its peak intensity pronounced on the time axis is referred to as “autocorrelation wave”.

Now, it will be described how the encoder 100 converts the light pulse 70 to produce the encoded light pulse train 80 and the decoder 200 decodes the encoded light pulse train to produce an autocorrelation wave 90. In other words, it will be described how the SSFBG 50a temporally spreads the light pulse 70 to produce the chip pulse train 80 and the SSFBG 50b decodes the train 80 to produce the autocorrelation wave 90, i.e. regenerated light pulses.

When the single light pulse 70 shown in FIG. 2 is input through the optical circulator 10 to the SSFBG 50a, the Bragg-reflected lights from the unit FBGs Aₐ₁, Aₐ₂, Aₐ₃ and Aₐ₄ are produced. The Bragg-reflected lights from the unit FBGs Aₐ₁, Aₐ₂, Aₐ₃ and Aₐ₄ are now denoted by 101, 102, 103 and 104, respectively. Thus, the single light pulse 70 shown in FIG. 2 is temporally spread to be converted to the Bragg-reflected lights 101 to 104, forming the encoded light pulse train 80.

In FIG. 2, above the optical fiber transmission path 18 connecting the transmitter end 110 to the receiver end 210, the Bragg-reflected lights 101-104 are shown as four light pulses temporally spread over the time axis, which form a specific chip pulse train depending on the unit FBGs Aₐ₁-Aₐ₄. Accordingly, the chip pulse train 80 is understood as a train or stream of chip pulses obtained by temporally spreading a light pulse input to the encoder 100 over the time axis.

The relative phases of these Bragg-reflected lights 101-104 forming the chip pulse train 80 may be given as (0, 0.25, 0.5, 0.75). The phase difference between Bragg-reflected lights 101 and 102 is 0.25. Also the phase differences between Bragg-reflected lights 102 and 103, and between Bragg-reflected lights 103 and 104 are equal to 0.25.

The chip pulse train 80 output from the optical circulator 10 is transmitted over the optical fiber transmission paths 18 and 20 to enter the SSFBC 50b. The SSFBG 50b is the same in structure as well as input and output ends as the SSFBG 50a. More specifically, the SSFBG 50a has the unit FBGs Aₐ₁, Aₐ₂, Aₐ₃ and Aₐ₄ arranged sequentially in the order from the input end, while the SSFBG 50b has the unit FBGs A_{b1}, A_{b2}, A_{b3} and A_{b4} similarly arranged sequentially in the order from the input end.

FIG. 3A plots temporal waveforms of the Bragg-reflected lights, or chip pulse trains, 201, 202, 203 and 204 produced respectively by the unit FBGs A_{b1}, A_{b2}, A_{b3} and A_{b4}, caused by Bragg reflection, wherein the abscissa represents the time axis. The relation of earliness and lateness is denoted by numerals from 1 to 7 for descriptive purpose, wherein a smaller numeral represents an earlier time.

The chip pulse train 80 input to the SSFBG 50b causes Bragg reflection firstly at the unit FBG A_{b1}, as shown in FIG. 2. The reflected light obtained by Bragg reflection at the unit FBG A_{b1} is now denoted as Bragg-reflected light 201. Similarly, the reflected lights obtained by Bragg reflection at the unit FBGs A_{b2}, A_{b3} and A_{b4} are denoted as Bragg-reflected lights 202, 203 and 204, respectively.

The chip pulses 101, 102, 103 and 104 comprised of the chip pulse train 80 go through Bragg reflection at the unit FBG A_{b1}, and sequenced on the time axis denoted by reference numeral 201 in FIG. 3A. The chip pulse 201 obtained by Bragg reflection at the unit FBG A_{b1} is a light pulse peaked at the position denoted by the numeral 1 on the time axis. The chip pulse 102 obtained by Bragg reflection at the unit FBG A_{b1} is a light pulse peaked at the position denoted by the numeral 2 on the time axis. Similarly, the chip pulses 103 and 104 obtained by Bragg reflection at the unit FBG A_{b1} are light pulses peaked at the positions denoted by the numerals 3 and 4, respectively, on the time axis.

Also at the unit FBG A_{b2}, the light pulses 101, 102, 103 and 104 forming the chip pulse train 80 go through Bragg reflection, and sequenced on the time axis denoted by reference numeral 202 in FIG. 3A. The Bragg-reflected light 202 reflected at the unit FBG A_{b2} has its relative phase value increased by 0.25 from the value of Bragg-reflected light 201. Accordingly, as compared with the chip pulse train 201 sequenced on the time axis, the chip pulse train 202 sequenced on the time axis has values obtained by adding 0.25 to each of the relative phase values of the individual chip pulses. More specifically, the chip pulse train 201 sequenced on the time axis has relative phase values of (0, 0.25, 0.5, 0.75) as read from right to left, while the chip pulse train 202 sequenced on the time axis has relative phase values of (0.25, 0.5, 0.75, 0), respectively increased by 0.25, as read from right to left.

Note that simple addition of 0.25 may give the relative phase values of the chip pulse train 202 as (0.25, 0.5, 0.75, 1), where the reason why the last value in the fourth place has a value of 0, rather than 1, is that, as has been described previously, the relative phase values of 0 and 1 have the same meaning in the expression of phase.

Similarly, the chip pulse train 203 sequenced on the time axis has relative phase values of (0.5, 0.75, 1, 1.25)=(0.5, 0.75, 0, 0.25), after adding 0.5 to the relative phase values of (0, 0.25, 0.5, 0.75) of the chip pulse train 201 sequenced on the time axis. Also similarly, the chip pulse train 204 sequenced on the time axis has relative phase values of (0.75, 1, 1.25, 1.5)=(0.75, 0, 0.25, 0.5), after adding 0.75 to the relative phase values of (0, 0.25, 0.5, 0.75) of the chip pulse train 201 sequenced on the time axis.

FIG. 3B plots the autocorrelation wave 90 of the input light pulse regenerated by the SSFBG 50b. The abscissa represents the time axis, which is matched to the time axis shown in FIG. 3A. The autocorrelation wave is given by the Bragg-reflected lights 201, 202, 203 and 204 obtained from the individual unit FBGs of the SSFBG 50b, and is given as the full total of the Bragg-reflected lights 201-204 illustrated in FIG. 3A. At the point of time denoted by the numeral 4 on the time axis in FIG. 3B, the light pulses relevant to the Bragg-reflected lights 201-204 are summed up while keeping the same phase, i.e. in phase, so as to exhibit the highest peak. The individual chip pulses overlap with each other also at the points of time other than those denoted by the numeral 4 on the time axis in FIG. 3B while keeping the same phase, wherein the resultant peaks are smaller than the largest peak at the point of time denoted by the numeral 4, because the overlapped pulses are fewer than 4, i.e. the number of the pulses may be equal to 3, 2 or 1.

As has been described in the above, the light pulse 70 is temporally spread by the SSFBG 50a to produce the chip pulse train 80, which is in turn input to the SSFBG 50b to produce the autocorrelation wave 90. The above description, directed to the case of using a 4-bit relative phase (0, 0.25, 0.5, 0.75), is also applicable to cases having other types of relative phase.

The autocorrelation wave 90 shown in FIG. 3B may supposedly be produced by a mechanism described below. The peak waveform, formed at the position denoted by the numeral 1 on the time axis, is ascribable to the Bragg-reflected light 201 reflected by the unit FBG A_{b1} corresponding to the chip pulse 101. Accordingly, the amplitude of the waveform appearing at the position denoted by the numeral 1 on the time axis equals to the amplitude of the chip pulse.

The peak waveform, formed at the position denoted by the numeral 2 on the time axis, is ascribable to the sum of the Bragg-reflected lights 202 and 201 reflected by the unit FBGs A_{b1} and A_{b2} corresponding to the chip pulses 102 and 101, respectively. The sum of both lights is resultant from the addition made between the light chip pulses in phase with each other having the relative phase values thereof equal to 0.25, so that the resultant amplitude is doubled from the amplitude of the chip pulse.

The amplitudes of the peak waveforms, formed thereafter at the positions denoted by numerals from 3 to 7 on the time axis, are obtained based on the same mechanism as described in the above, and the amplitudes thereof are given as tripled, quadrupled, tripled, doubled, and singled, respectively. In FIG. 3B, factors of increase in amplitude of the individual peak waveforms are given in the parentheses, at the individual peak positions. The total of the amplitude of these peak waveforms, formed at the positions denoted by numerals from 1 to 7 on the time axis, may be obtained by sequentially summing up the factors such as 1+2+3+4+3+2+1=16. The summation may be converted into energy of 256 times (=16² times) per chip pulse. In other words, the total energy of the autocorrelation wave 90 is 256 times as large as the energy of a single chip pulse.

The description in the above dealt with the case where the SSFBG 50a which serves as the encoder 100 and the SSFBG 50b which serves as the decoder 200 have the same relative phase set thereto. In other words, the above description was made on the case where a light pulse is temporally spread by the SSFBG 50a into a chip pulse train, which is then input to the SSFBG 50b and output as an autocorrelation wave 90.

A chip pulse train decoded by a decoder of the optical signal multiplex transceiver system, having a structure different from that of the encoder which produced the chip pulse train, will not produce a pronounced peak on the time axis. The output light from the decoder in this case is referred to as “cross-correlation wave”.

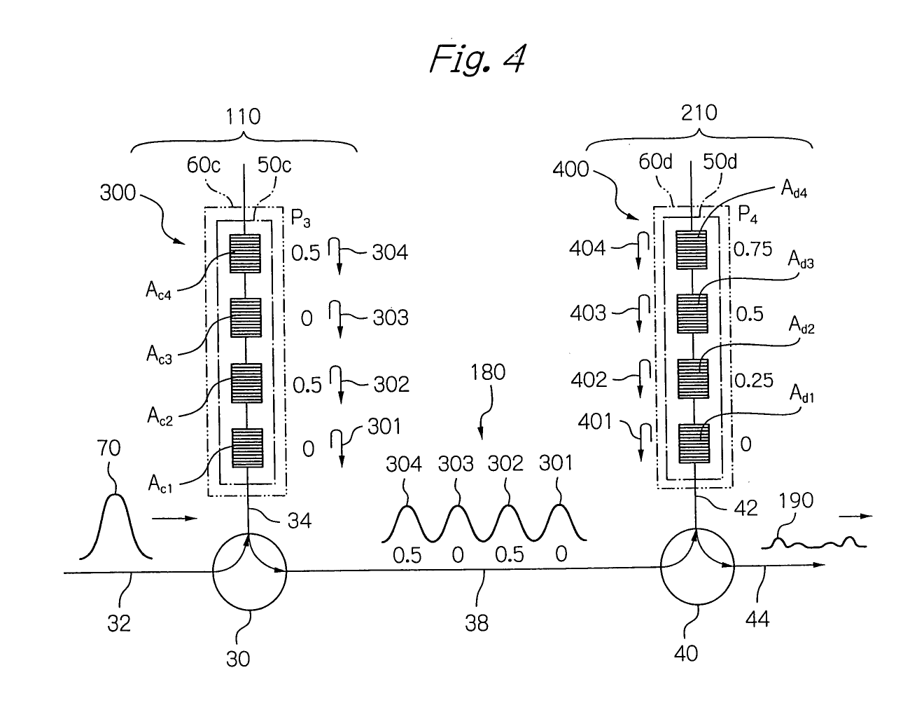

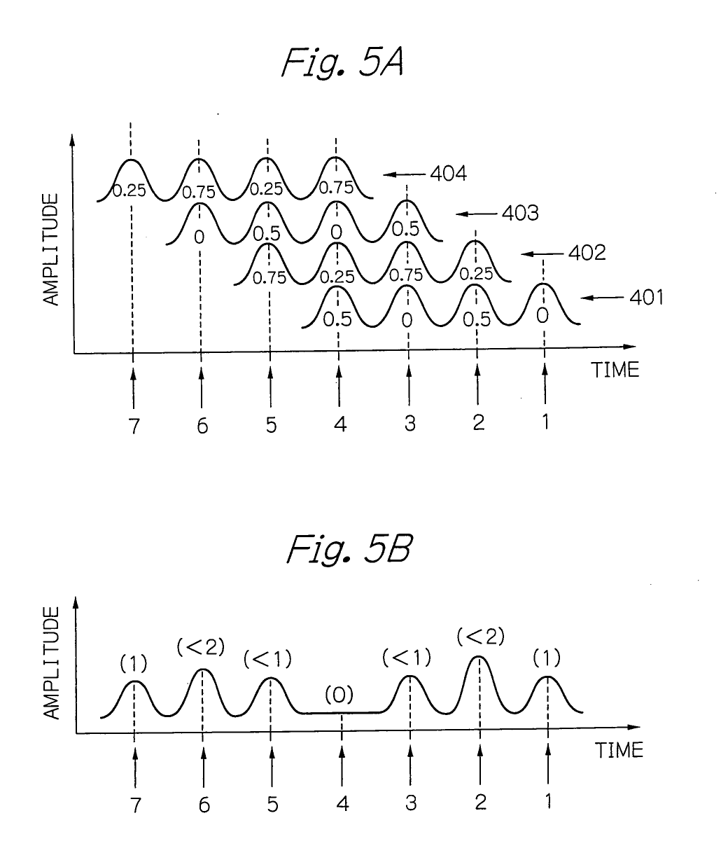

Next, referring to FIGS. 4, and 5A and 5B, it will be described how an optical pulse time spreading device operates in principle which is provided with a pair of SSFBGs having the built-in periodical structures of refractive index thereof different from each other in producing a chip pulse train, and decoding a light pulse. In other words, an exemplary case will be described which has a couple of optical pulse time spreading devices having SSFBG 50c and 50d used as a chip pulse converter 300 and a light pulse regenerator 400, respectively. In this case, a cross-correlation wave, which is an output light developed from the SSFBG 50d serving as a decoder 400, does not show a distinctive peak on the time axis.

In addition to FIG. 4, a reference will be made to FIG. 5A, which plots temporal waveforms of chip pulse trains 401, 402, 403 and 404 respectively obtained by Bragg reflection from unit FBGs A_{d1}, A_{d2}, A_{d3} and A_{d4} included in the SSFBG 50d. Further, FIG. 5B plots a temporal waveform of a cross-correlation wave of an input light pulse, decoded by the SSFBG 50d as the decoder 400. The chip pulse trains 401, 402, 403 and 404 are obtained as a result of temporally spreading, by the unit FBGs A_{d1}, A_{d2}, A_{d3} and A_{d4}, chip pulses 301, 302, 303 and 304 respectively output from the SSFBG 50c.

As shown in FIG. 4, the encoder 300 and the decoder 400 are connected to each other via an optical circulator 30, an optical fiber transmission path 38 and an optical circulator 40. The circulator 30 has a terminal 32 to which a light pulse 70 is input, another terminal 34 connected to the encoder 100 for outputting the light pulse 70 to the encoder 100 and receiving Bragg-reflected lights 301-304 generated by the encoder 100, and a further terminal 38 connected to the optical fiber transmission path 38 for outputting a chip pulse train 180 comprised of the Bragg-reflected lights 301-304. Similarly, the circulator 40 has a terminal 38 to which the chip pulse train 180 is input, a terminal 42 connected to the decoder 200 for outputting the pulse train 180 to the decoder 400 and receiving an cross-correlation wave 190 generated by the decoder 400, and another terminal 44 for outputting the across-correlation wave 190.

As shown in FIG. 4, the input light pulse 70 is routed through the optical circulator 30 to the SSFBG 50c for temporally spreading, and again routed through the optical circulator 30 to be output in the form of chip pulse train 180. The SSFBG 50c illustrated in FIG. 4 is comprised of four unit FBGs A_{c1}-A_{c4} arranged in the wave propagation direction in the optical fiber 60c. Accordingly, the number of chip pulses output from the SSFBG 50c and sequenced over the time axis is four.

The unit FBGs A_{c1}, A_{c2}, A_{c3} and A_{c4} included in the SSFBG 50c respectively generate the chip pulses 301, 302, 303 and 304.

When the light pulse 70 is input to the SSFBG 50c, Bragg-reflected lights 301-304 are produced by unit FBGs A_{c1}-A_{c4}, respectively, and then output. Relative phases (P₃, FIG. 4) of the individual Bragg-reflected lights 301, 302, 303 and 304 are given as 0, 0.5, 0 and 0.5, respectively. The values of relative phase may be expressed in the form of sequence of (0, 0.5, 0, 0.5). In other words, the rule for temporally spreading a light pulse set to the SSFBG 50c corresponds to the case specified by m=1, N=4 and b=0.25, giving the minimum unit b+(m/N) of relative phase of 0.5. Accordingly, a sequence of relative phase values set to the unit FBGs included in the SSFBG 50c may be given as (0, 0.5, 0, 0.5).

In contrast, in the SSFBG 50d, the relative phase values (P₄, FIG. 4) of the individual Bragg-reflected lights 301, 302, 303 and 304 are given in the form of sequence of (0, 0.25, 0.5, 0.75). In short, the rule for temporally spreading a light pulse 70 set to the SSFBG 50d corresponds to the case specified by m=0, N=4 and b=0.25, giving the minimum unit b+(m/N) of relative phase of 0.25. Accordingly, a sequence of relative phase values set to the unit FBGs, forming the SSFBG 50d in the decoder 400, may be given as (0, 0.25, 0.5, 0.75).

It will now be described how the SSFBG 50c temporally spreads the light pulse 70 to produce the chip pulse train 180 and the SSFBG 50d produces a cross-correlation wave 190 from the chip pulse train.

When the single light pulse 70 shown in FIG. 4 is input through the optical circulator 30 to the SSFBG 50c, the Bragg-reflected lights from the unit FBGs A_{c1}-A_{c4} are produced. The Bragg-reflected lights from the unit FBGs A_{c1}-A_{c4} are now denoted by 301-304, respectively. In other words, a single light pulse shown in FIG. 4 is temporally spread into the Bragg-reflected lights 301-304, forming the encoded light pulse train 180.

In FIG. 5A, above the optical fiber transmission path 38 connecting the transmitter end 110 and the receiver end 210, the Bragg-reflected lights 301-304 are shown as four light pulses temporally spread over the time axis, which form a specific chip pulse train depending on the unit FBGs A_{c1}-A_{c4}, respectively. Accordingly, the chip pulse train 180 is understood as a train of chip pulses obtained by temporally spreading the light pulse 70 input to the encoder 300 over the time axis.

The relative phases of these Bragg-reflected lights 301-304 forming the chip pulse train 180 may be given as (0, 0.5, 0, 0.5). The phase difference between Bragg-reflected lights 301 and 302 is 0.5. Also the phase differences between Bragg-reflected lights 302 and 303, and between Bragg-reflected lights 303 and 304 are equal to 0.5.

The chip pulse train 180 output from the optical circulator 30 is transmitted over the optical fiber transmission path 38 and through the optical circulator 40 to enter the SSFBC 50d.

Referring to FIGS. 5A and 5B, it will be described how a chip pulse train 180 output from the SSFBG 50c is input into the SSFBG 50d and then output therefrom in the form of cross-correlation wave 190. FIGS. 5A and 5B are useful for understanding the process of producing the cross-correlation wave 190 from the chip pulse train 180.

FIG. 5A plots temporal waveforms of the chip pulse trains 401, 402, 403 and 404 produced respectively by the unit FBGs A_{d1}, A_{d2}, A_{d3} and A_{d4}, based on Bragg reflection, wherein the abscissa represents the time axis. The relation of earliness and lateness is expressed by numerals from 1 to 7 for descriptive purpose, wherein a smaller numeral represents an earlier time.

The chip pulse train 180 input to the SSFBG 50d causes Bragg reflection firstly at the unit FBG A_{d1}. The reflected light obtained by Bragg reflection at the unit FBG A_{d1} is now denoted as Bragg-reflected light 401. Similarly, the reflected lights obtained by Bragg reflection at the unit FBGs A_{d2}, A_{d3} and A_{d4} are denoted as Bragg-reflected lights 402, 403 and 404, respectively.

The chip pulses 301-304 forming the chip pulse train 180 go through Bragg reflection at the unit FBG A_{d1}, and sequenced on the time axis denoted by 401 illustrated in FIG. 5A. The chip pulse 301 obtained by Bragg reflection at the unit FBG A_{d1} is a light pulse peaked at the position denoted by the numeral 1 on the time axis. The chip pulse 302 obtained by Bragg reflection at the unit FBG A_{d1} is a light pulse peaked at the position denoted by the numeral 2 on the time axis. Similarly, the chip pulses 303 and 304 obtained by Bragg reflection at the unit FBG A_{d1} are light pulses peaked at the positions denoted by the numerals 3 and 4, respectively, on the time axis.

Also at the unit FBG A_{d2}, the light pulses 301-304 forming the chip pulse train go through Bragg reflection, and sequenced on the time axis denoted by 402 in FIG. 5A. The Bragg-reflected light 402 reflected at the unit FBG A_{d2} has a relative phase value increased by 0.25 from the value of Bragg-reflected light 401. Accordingly, as compared with the chip pulse train 401 sequenced on the time axis, the chip pulse train 402 sequenced on the time axis has values obtained by adding 0.25 to each of the relative phase values of the individual chip pulses. More specifically, the chip pulse train 401 sequenced on the time axis has relative phase values of (0, 0.5, 0, 0.5) as read from right to left in the figure, while the chip pulse train 402 sequenced on the time axis has relative phase values of (0.25, 0.75, 0.25, 0.75), respectively increased by 0.25, as read from right to left.

Similarly, the chip pulse train 403 sequenced on the time axis has relative phase values of (0.5, 0, 0.5, 0), after adding 0.5 to the relative phase values of (0, 0.5, 0, 0.5) of the chip pulse train 401 sequenced on the time axis. Likewise, the chip pulse train 404 sequenced on the time axis has relative phase values of (0.75, 1.25, 0.75, 1.25)=(0.75, 0.25, 0.75, 0.25), after adding 0.75 to the relative phase values of (0, 0.5, 0, 0.5) of the chip pulse train 401 sequenced on the time axis.

FIG. 5B plots a temporal waveform of the cross-correlation wave 190 output from the SSFBG 50d. The abscissa represents the time axis, which is matched to the time axis in FIG. 5A. The cross-correlation wave 190 is given by the Bragg-reflected lights 401, 402, 403 and 404 obtained from the individual unit FBGs A_{d1}-A_{d4} of the SSFBG 50d, and is given as the full total of the Bragg-reflected lights 401-404 shown in FIG. 5A.

At a point of time denoted by numeral 1 on the time axis in FIG. 5B, the peak is formed only by the rightmost chip pulse, in the figure, in the Bragg-reflected light 401, so that the amplitude thereof equals to the amplitude of a single chip pulse. At a point of time denoted by numeral 2 on the time axis, the peak is formed by the sum of the second rightmost chip pulse in the Bragg-reflected light 401 and the rightmost chip pulse in the Bragg-reflected light 402. Since the chip pulses have phase values of 0.5 and 0.25, respectively, so that the amplitude of the peak formed as a result of summation may be smaller than the sum of the amplitude of two chip pulses. This is expressed as “<2” in the parentheses in FIG. 5B.

Similarly, the amplitude of the peak is smaller than the amplitude of a single chip pulse at points of time denoted by numerals 3 and 5 on the time axis. Furthermore, the amplitude of the peak is smaller than the sum of the amplitude of the two chip pulses at a point of time denoted by numeral 6 on the time axis. At a point of time denoted by numeral 4 on the time axis, the peak has its amplitude equal to zero because the overlapped chip pulses are just cancelled with each other. At a point of time denoted by numeral 7 on the time axis, the peak is formed only by the leftmost chip pulse in the Bragg-reflected light 404, so that the amplitude thereof equals to the amplitude of a single chip pulse.

In FIG. 5B, factors of increase in amplitude of the individual peak waveforms are given in the parentheses, at the individual peak positions. The total of the amplitude of these peak waveforms, formed at the positions denoted by the numerals from 1 to 7 on the time axis, may be obtained by sequentially summing up the factors, but may be smaller than 1+2+1+0+1+2+1=8. The summation may be converted into energy to give a value smaller than 64 times (=82 times) per chip pulse. In other words, the total energy of the cross-correlation wave 190 is smaller than a value 64 times as large as the energy of a single chip pulse.

Whereas the energy of the autocorrelation wave 90 was 256 times as large as the energy of a single chip pulse, the energy of the cross-correlation wave 190 is only 64 times as large as the energy of a single chip pulse. This indicates that the energy of autocorrelation wave 90 is four times (=256/64 times) as large as that of the cross-correlation wave 190. It was also seen that, as shown in FIG. 3B, the peak intensity of the autocorrelation wave 90 was four times as high as that of a single chip pulse, which means 16 times on the energy basis. On the other hand, as seen from FIG. 5B, the peak intensity of the cross-correlation wave 190 is zero.

It is therefore understood from the above that the optical pulse time spreading device of the illustrative embodiments may achieve a large S/N ratio, and may ensure the peak intensity of the autocorrelation wave sufficiently larger than that of the cross-correlation wave.

As has been described in the above, by arranging the i-th unit FBGs forming the SSFBG so as to make the i-th chip pulses have its relative phase equal to 2Π[b+(m/N)]*(i−1), the adjacent chip pulses in a resultant chip pulse train will be out of phases from each other, when acting as optical carriers. That causes the adjacent chip pulses forming the chip pulse train to be interfered with each other so as to be effectively attenuated to the extent that a larger S/N ratio may be achieved. In this way, the optical intensity of the overlapped portion on the time axis of the adjacent chip pulses forming the chip pulse train may be attenuated, and the S/N ratio may thereby effectively be made less dependent on a code used for encoding and may thus be made larger.

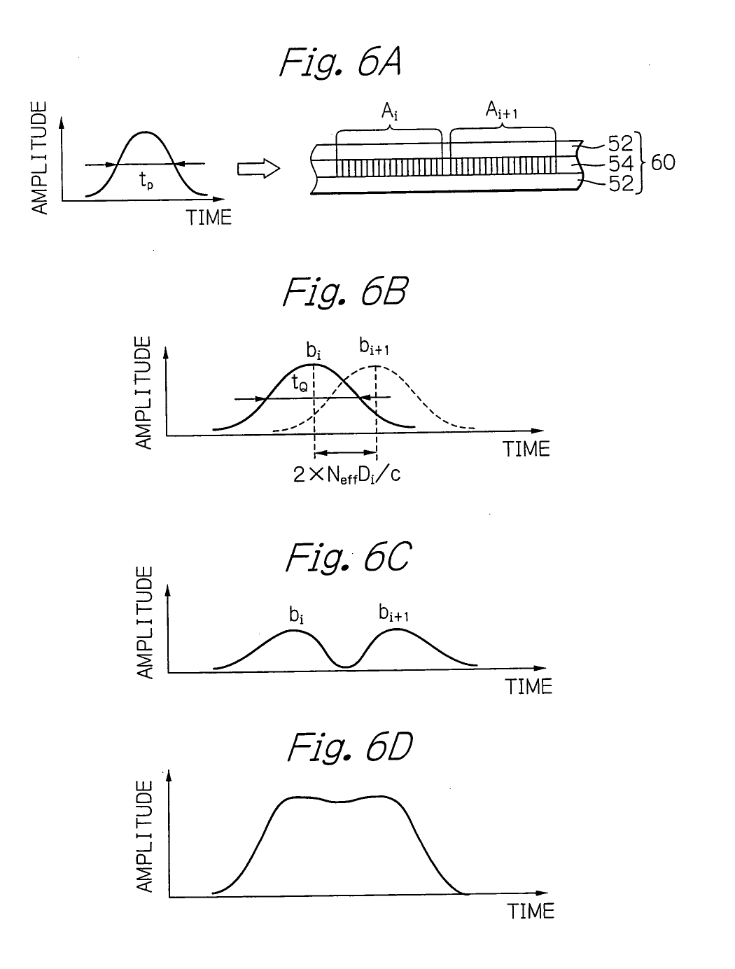

With respect to relative phase difference of the adjacent chip pulses, the effect of interference of the chip pulses produced by the adjacent unit FBGs will be described, referring to FIGS. 6A to 6D.

FIG. 6A schematically illustrates when the SSFBG 50 included in an encoder receives a light pulse having its full width at half maximum on the time axis equal to tₚ. FIG. 6B independently plots temporal waveforms of chip pulses bᵢ and bᵢ₊₁ produced by the i-th and (i+1)-th unit FBGs, respectively. FIG. 6C plots a temporal waveform of a chip pulse train obtained by adding, while considering the phase, the chip pulses bᵢ and bᵢ₊₁ respectively produced by the i-th and (i+1)-th unit FBGs to each other, wherein the relative phases of the chip pulses bᵢ and bᵢ₊₁ as optical carriers differ by Π radian from each other. FIG. 6D plots a temporal waveform of a chip pulse train obtained by adding, while considering the phase, the chip pulses bᵢ and bᵢ₊₁ respectively produced by the i-th and (i+1)-th unit FBGs, wherein the relative phases of the chip pulses bᵢ and bᵢ₊₁ as optical carriers are identical to, or in phase with, each other.

As shown in FIG. 6B, when c is the speed of light, the chip pulses bᵢ and bᵢ₊₁ are peaked at positions 2*N_{eff}Dᵢ/c away from each other on the time axis, and allow partial overlapping on the time axis. If the relative phases of the chip pulses bᵢ and bᵢ₊₁ as optical carriers differ by Π radian from each other, the overlapped portion is interfered with each other to be attenuated, as shown in FIG. 6C, so that the chip pulses bᵢ and bᵢ₊₁ may give clearly isolated peaks.

In contrast, if the chip pulses bᵢ and bᵢ₊₁ as optical carriers are relatively in phase, the chip pulses bᵢ and bᵢ₊₁ are unified with each other so that the overlapped portion is not attenuated without interference, as shown in FIG. 6D, rather than giving clearly isolated peaks.

As a consequence, the chip pulses bᵢ and bᵢ₊₁ as optical carriers, when differing in relative phase by Π, can exist as isolated peaks on the time axis, whereas they cannot exist as isolated peaks when they are in phase. The autocorrelation wave and the cross-correlation wave produced by the decoder through adding the chip pulse trains may be more unlikely to depend on the pattern of arrangement of, the chip pulses forming the chip pulse train on the time axis, if the chip pulses are more clearly isolated on the time axis. As a consequence, a larger S/N ratio may be ensured in the process of decoding.

In general, as the relative phase difference between the adjacent chip pulses as optical carriers changes from zero to Π, the isolation of the chip pulses correspondingly becomes more distinctive. In other words, the autocorrelation wave and the cross-correlation wave are more unlikely to depend on the pattern of arrangement of the chip pulses included in the chip pulse train on the time axis if the relative phase difference between the adjacent chip pulses as optical carriers is closer to Π.

In the SSFBG forming the optical pulse time spreading device of the illustrative embodiments, the relative phase difference between the chip pulses produced by the adjacent unit FBGs is not equal to Π, but not zero either. For this reason, a sufficiently large S/N ratio may be achieved in the process of decoding performed by the optical pulse time spreading device of the illustrative embodiments, the degree of which is not so distinctive though as compared with the case where the relative phase difference is Π.

The possibility of achieving a sufficiently large S/N ratio according to the optical pulse time spreading device of the illustrative embodiments has quantitatively been described in the above, making reference to an exemplary case where the relative phase difference b+(m/N) between the adjacent unit FBGs is represented by b=0.25, m=0 and 1, N=4, with reference to FIGS. 2 through 5B.

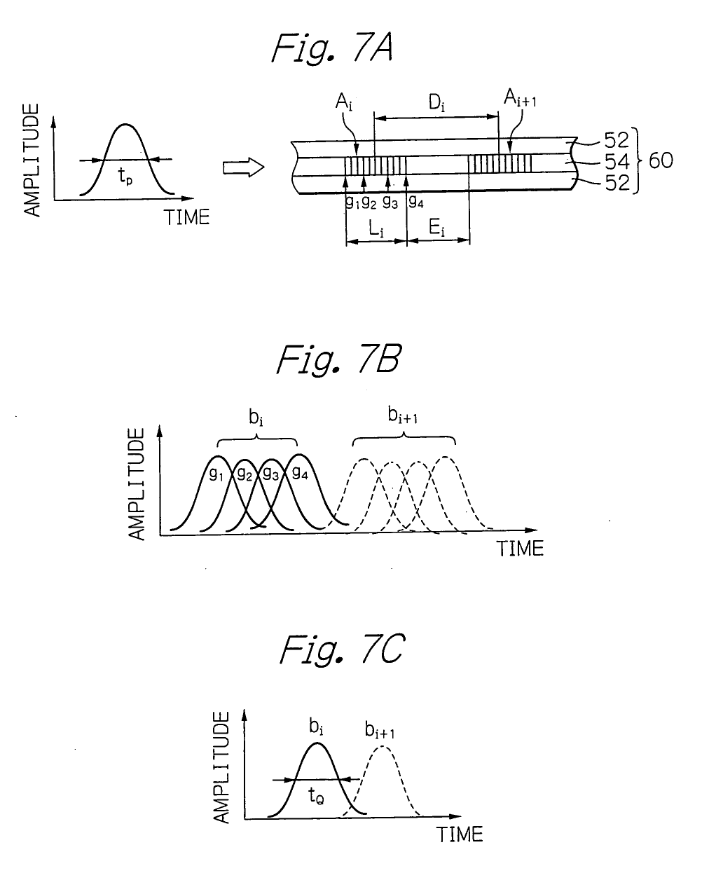

Well, it will be described, referring to FIGS. 7A, 7B and 7C, how the ratio of the unit grating length to the unit segment length effects on the ratio of the autocorrelation wave components to the cross-correlation wave components produced by a decoder, i.e. S/N ratio. FIG. 7A schematically illustrates when a light pulse having its full width at half maximum equal to tₚ on the time axis is input to an SSFBG included in an encoder. The left part of FIG. 7A plots a temporal waveform of a light pulse to be input to the SSFBG. The right part of FIG. 7A is a schematic, enlarged cross-sectional view of part cut out from the SSFBG. FIG. 7A representatively illustrates the i-th and the (i+1)-th unit FBG denoted by Aᵢ and Aᵢ₊₁, respectively. The unit grating length is Lᵢ, the unit segment length is Dᵢ, and the length of the phase shifter is Eᵢ. In the description hereinafter, the full width at half maximum on the time axis may sometimes simply be referred to as “time width”.

The light pulse to be input to the SSFBG successively goes through Bragg reflection at the individual unit FBGs forming the SSFBG. Referring now to the i-th unit FBG shown in FIG. 7A, the temporal waveforms of the Bragg-reflected light components reflected at both ends g₁ and g₄ and equally-spaced points g₂ and g₃ of the i-th unit FBG are given in solid lines in FIG. 7B. An actual temporal waveform of the Bragg-reflected light obtained from the i-th unit FBG may be determined as a sum of the Bragg-reflected light components reflected at the points g₁-g₄. More strictly, the temporal waveform of the Bragg-reflected light obtained from the i-th unit FBG may be determined by integrating the Bragg-reflected light components obtained from all successive portions of the i-th unit FBG. As a consequence, the temporal waveform of the Bragg-reflected light obtained from the i-th unit FBG is given as a chip pulse denoted by bᵢ, having a time width of t_{Q} as shown in FIG. 7C.

Also the temporal waveforms of the Bragg-reflected light components reflected from the (i+1)-th unit FBG may similarly be given as those, denoted by bᵢ₊₁, drawn in broken lines in FIGS. 7B and 7C. In general, the time width t_{Q} of the temporal waveforms of the Bragg-reflected lights reflected by the individual unit FBGs may be expressed by the expression (1) below, using the time width tₚ of the temporal waveform of an input light pulse, the unit grating length Lᵢ, the effective refractive index N_{eff} of the optical fiber, and the speed of light c:

t_{Q}=tₚ+(2*N_{eff}Lᵢ/c) (1)

Accordingly, in order to reduce the portions of overlapping of the adjacent chip pulses, bᵢ and bᵢ₊₁, on the time axis, it may be understood that unit segment length Dᵢ, which is the distance between the adjacent unit FBGs, is preferably set so as to satisfy the expression (2) below:

2*(Dᵢ−Lᵢ)≧(t_{Q}−tₚ)*(c/N_{eff}) (2)

Since 2*Lᵢ(t_{Q}−tₚ)*(c/N_{eff}) is derived from the expression (1), the expression (2) may be written as the expression (3) below:

2*(Dᵢ−Lᵢ)≧2*Lᵢ (3)

and thereby

Dᵢ/2≧Lᵢ (4)

may be obtained.

In short, by setting the unit grating length Lᵢ of the SSFBG shorter than 1/2 of the unit segment length Dᵢ, the overlapping of the adjacent chip pulses on the time axis, included in the chip pulse train, may be reduced to a negligible degree. Accordingly, the S/N ratio may effectively be made less dependent on the code used for encoding, and may be made larger.

In other words, by arranging the i-th unit FBG forming the SSFBG so as to give a relative phase equal to 2Π[b+(m/N)]×(i−1) with respect to the first chip pulse, and by setting the unit grating length of each of the first to N-th unit FBGs in the longitudinal direction shorter than the unit segment length which represents the distance between the adjacent i-th unit FBG and the (i+1)-th unit FBG, the following effects may be obtained. That is, the S/N ratio may very effectively be made less dependent on a code used for encoding, and may be made larger, as a result of synergistic effect of attenuation of the adjacent chip pulses included in the chip pulse train, and reduction in overlapping of both chip pulses on the time axis.

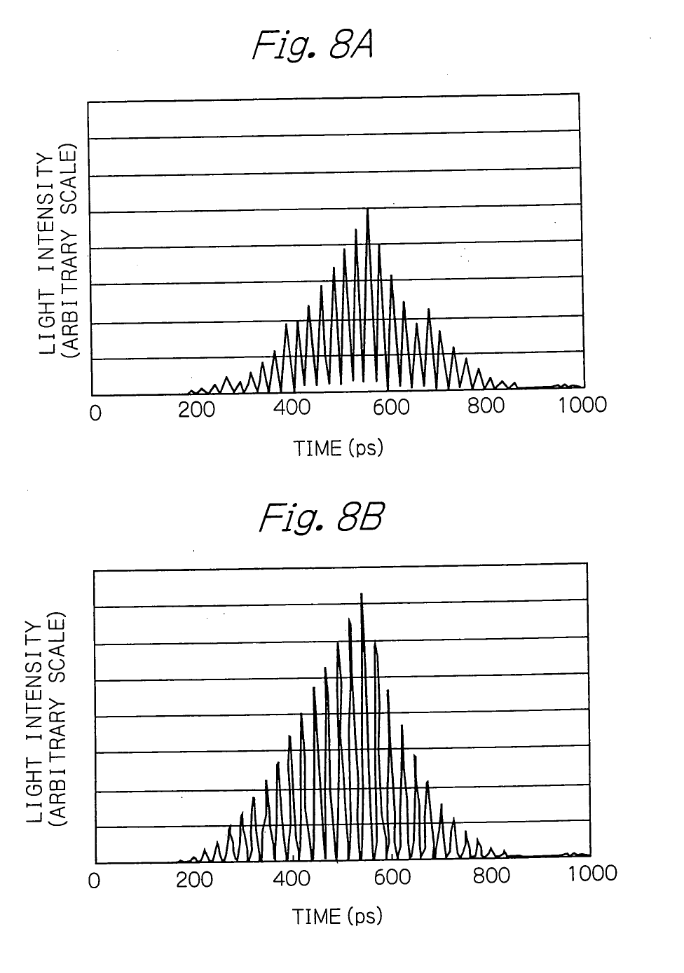

Referring now to FIGS. 8A-11B, paragraphs below will describe results of simulation conducted in order to examine the code dependence of the energy ratio of the autocorrelation wave components to the cross-correlation wave components, i.e. S/N ratio, produced in the process of decoding, obtained from SSFBGs having two types of relation between the unit grating length Lᵢ and the unit segment length Dᵢ. In FIGS. 8A-11B, the abscissa represents time in ps (picosecond), and the ordinate represents intensity of light in an arbitrary scale.

In this simulation, the periodicity A of modulation of effective refractive index of the unit FBG was set to 540 nm, and the unit segment length Dᵢ was set to 1.3 mm. The simulation was conducted assuming the SSFBGs set with two types of codes, which include code R represented by m=0, b=1/32 and N=16 for the minimum unit b+(m/N) of relative phase, and code S represented by m=4, b=1/32 and N=16. The full width at half maximum on the time axis of the light pulse to be input to the SSFBG is 12 ps.

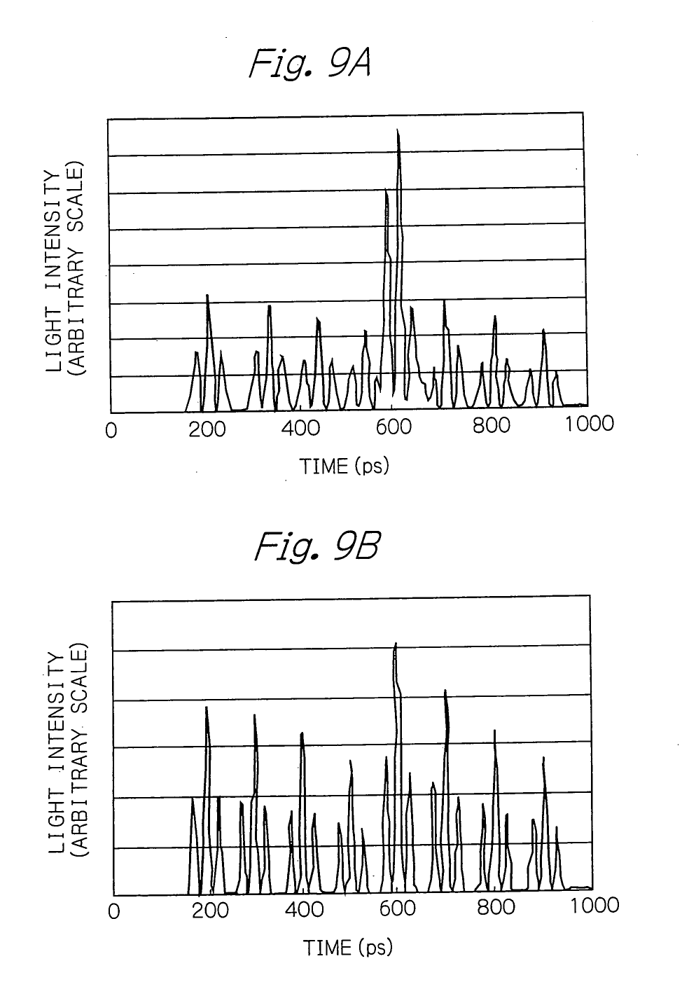

FIGS. 8A and BB plot autocorrelation waveforms based on the code R with respect to a signal encoded using code R. Specifically, FIG. 8A corresponds to the case with Lᵢ=Dᵢ, Eᵢ=0, and is therefore Lᵢ/Dᵢ=1, and FIG. 8B corresponds to the case with Lᵢ=Eᵢ=(1/2)Dᵢ and is hence Lᵢ/Dᵢ=1/2. FIGS. 9A and 9B plot cross-correlation waveforms obtained when a signal encoded with the code R used was decoded using the code S. Specifically, FIG. 9A corresponds to the case with Lᵢ=Dᵢ, Eᵢ=0, and FIG. 9B corresponds to the case with Lᵢ=Eᵢ=(1/2)Dᵢ.

It is understood from FIGS. 8A and 8B that the energy of the autocorrelation waveform components is larger when the length Eᵢ of the phase shifter is ensured to as long as Lᵢ=Eᵢ=(1/2)Dᵢ as compared with the case where the length Eᵢ of the phase shifter is ensured only to as much as producing the phase difference equal to the minimum unit of relative phase so as to substantially achieve Eᵢ=0. More quantitatively, as compared with the case substantially assumed as Eᵢ=0, the energy of the autocorrelation waveform components when the length of the phase shifter is ensured to as long as Lᵢ=Eᵢ=(1/2)Dᵢ is larger by 0.9 decibel (dB).

Also, it is understood from FIGS. 9A and 9B that the peak intensity of the cross-correlation wave is smaller when the length of the phase shifter is ensured to as long as Lᵢ=Eᵢ=(1/2)Dᵢ as compared with the case substantially assumed as Eᵢ=0. More quantitatively, as compared with the case substantially assumed as Eᵢ=0, the energy of the cross-correlation wave when the length of the phase shifter is ensured to as long as Lᵢ=Eᵢ=(1/2)Dᵢ is smaller by 1.9 dB.

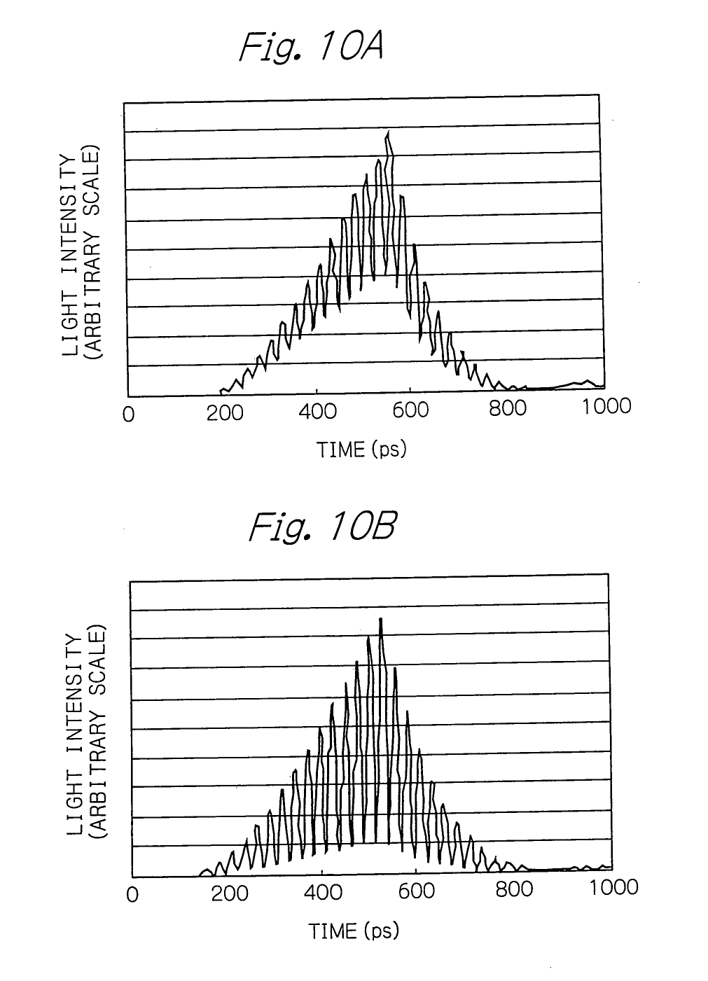

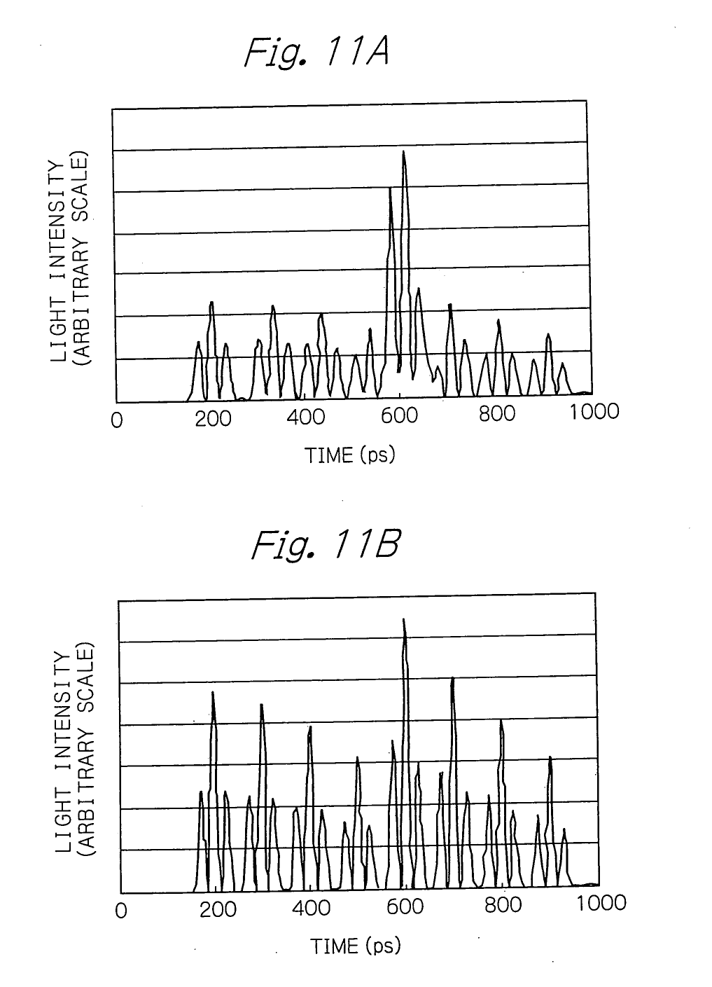

FIGS. 10A and 10B plot autocorrelation waveforms based on the code S with respect to a signal encoded with the code S used. Specifically, FIG. 10A corresponds to the case with Lᵢ=Dᵢ, Eᵢ=0, and FIG. 10B corresponds to the case with Lᵢ=Eᵢ=(1/2)Dᵢ. Further, FIGS. 11A and 11B plot cross-correlation waveforms obtained when a signal encoded with the code S used was decoded using the code R. Specifically, FIG. 11A corresponds to the case with Lᵢ=Dᵢ, Eᵢ=0, and FIG. 11B corresponds to the case with Lᵢ=Eᵢ=(1/2)Dᵢ.

It is understood from FIGS. 10A and 10B that the energy of the auto correlation waveform components is smaller when the length Eᵢ of the phase shifter is ensured to as long as Lᵢ=Eᵢ=(1/2)Dᵢ as compared with the case where the length Eᵢ of the phase shifter is ensured only to as much as producing the phase difference equal to the minimum unit of relative phase so as to substantially achieve Eᵢ=0. More quantitatively, as compared with the case substantially assumed as Eᵢ=0, the energy of the autocorrelation wave when the length of the phase shifter is ensured to as long as Lᵢ=Eᵢ=(1/2)Dᵢ is smaller by 0.7 dB.

Also, it is understood from FIGS. 11A and 11B that the peak intensity of the cross-correlation wave is larger when Lᵢ=Eᵢ=(1/2)Dᵢ is ensured as compared with the case substantially assumed as Eᵢ=0. More quantitatively, as compared with the case substantially assumed as Eᵢ=0, the energy of the cross-correlation wave when Lᵢ=Eᵢ=(1/2)Dᵢ is ensured is larger by 1.9 dB.

It may be understood from the illustration in the above that, for the case where the full width at half maximum on the time axis of the light pulse to be input to the SSFBG is 12 ps, so far as the ratio Lᵢ/Dᵢ of the unit grating length Lᵢ to the unit segment length Dᵢ is set to 1/2, the code dependence of the ratio of energy of the autocorrelation wave components to the cross-correlation wave components cannot fully be reduced.

The inventors then investigated into the degree of the ratio Lᵢ/Dᵢ of the unit grating length Lᵢ to the unit segment length Dᵢ suitable for thoroughly reducing the code dependence.

The code dependence of the ratio of energy of the cross-correlation wave components to the autocorrelation waveform components, described with reference to FIGS. 8A-11B, was based on the results of simulations assuming that the time width of a light pulse to be input to the SSFBG forming the encoder was 12 ps. The narrower time width of the input light pulse might reduce the degree of overlapping of the adjacent chip pulses on the time axis, but is still unable to exclude the overlapped portions. The inventors therefore investigated about which degree of the ratio Lᵢ/Dᵢ of the unit grating length Lᵢ to the unit segment length Dᵢ may be effective for reducing the overlapped portions.

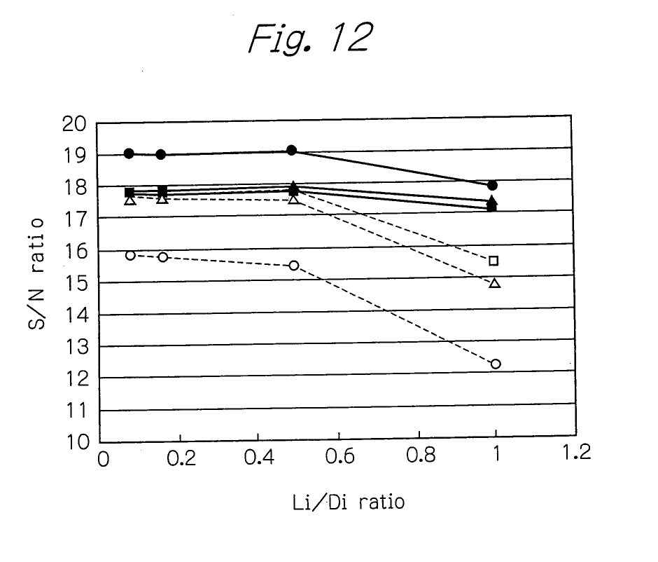

The code dependency of the ratio of energy of the autocorrelation wave components to the cross-correlation wave components upon the ratio Lᵢ/Dᵢ of the unit grating length Lᵢ to the unit segment length Dᵢ will be described with reference to FIG. 12. In FIG. 12, the abscissa represents Lᵢ/Dᵢ, and the ordinate represents the ratio of energy of the autocorrelation wave components to the cross-correlation wave components, that is, S/N ratio.

The S/N ratios were determined by independently finding the autocorrelation waveforms obtained by encoding a signal with the code R used, followed by decoding using the code R, and the cross-correlation waveforms obtained by encoding a signal using the code R followed by decoding using the code S. Simulations herein were made on three cases where the time width of a light pulse to be input to the SSFBG forming the encoder was varied among 3 ps, 12 ps and 24 ps. Open square plots, open triangle plots and open circle plots stand for the S/N ratios for the time width of the input light pulse of 3 ps, 12 ps and 24 ps, respectively.

On the other hand, also the S/N ratios were determined by independently finding the autocorrelation waveforms obtained by encoding a signal using the code S followed by decoding using the code S, and the cross-correlation waveforms obtained by encoding a signal using the code S followed by decoding using the code R. Also simulations herein were made on three cases where the time width of a light pulse to be input to the SSFBG forming the encoder was varied among 3 ps, 12 ps and 24 ps. Filled square plots, filled triangle plots and filled circle plots stand for the S/N ratios for the time width of the input light pulse of 3 ps, 12 ps and 24 ps, respectively.

It is seen from FIG. 12 that the S/N ratios are stabilized if the ratio Lᵢ/Dᵢ of the unit grating length Lᵢ to the unit segment length Dᵢ is set smaller than 1/2 under any above-described conditions. More specifically, even if the time width of the input light pulse is as wide as 24 ps, the S/N ratio does not depend on the code used for encoding, if the ratio Lᵢ/Dᵢ is set smaller than 1/2.

Referring to a case of optical communication using a bit rate, i.e. transmission rate, of 160 Gbit/s, the time length of the light pulses included in a light pulse signal to be transmitted is allowable up to several tens of picoseconds. The optical pulse time spreading device of the illustrative embodiments can suppress the code dependence of S/N ratio to a sufficiently small degree even if the time width of the input pulse is as wide as 24 ps, and is therefore suitable for use in decoder or encoder in optical communication based on the OCDM system.

For the case where the code set on the encoder and the code set on the decoder differ from each other, the cross-correlation wave output from the decoder will give a signal having more uniform intensity on the time axis, as the overlapping on the time axis of the adjacent chip pulses included in a chip pulse train input to the decoder becomes smaller. Accordingly, by applying the optical pulse time spreading device of the illustrative embodiments to an encoder and a decoder, the S/N ratio may be made less dependent on the code used for encoding, and may be made larger.

The entire disclosure of Japanese patent application No. 2008-160265 filed on Jun. 19, 2008, including the specification, claims, accompanying drawings and abstract of the disclosure, is incorporated herein by reference in its entirety.

While the present invention has been described with reference to the particular illustrative embodiments, it is not to be restricted by the embodiments. It is to be appreciated that those skilled in the art can change or modify the embodiments without departing from the scope and spirit of the present invention.

What is claimed is:

1. An optical pulse time spreading device comprising an optical fiber and a superstructured fiber Bragg grating (SSFBG) formed in said optical fiber,
said SSFBG comprising a plurality of unit fiber Bragg gratings (FBGs) having an effective refractive index of said optical fiber periodically varying in a longitudinal direction of said optical fiber, and a plurality of phase shifters having a constant effective refractive index,
each of said plurality of unit FBGs being arranged between adjacent ones of said plurality of phase shifters in the longitudinal direction,
each of said plurality of unit FBGs having a unit grating length in the longitudinal direction shorter than a unit segment length which is a distance between adjacent ones of said unit FBGs.

2. The device as claimed in claim 1, wherein the unit grating length is shorter than 1/2 of the unit segment length.

3. The device as claimed in claim 1, wherein said plurality of unit FBGs are represented by a first to an N-th unit FBG, where N is a natural number larger than unity,
each of said plurality of phase shifters being arranged between an i-th unit. FBG and an (i+1)-th unit FBG adjacent to the i-th unit FBG, where i is a parameter specifying any one of said first to N-th unit FBGs and a natural number less than N;
said device temporally spreading a light pulse input to said SSFBG to thereby produce a chip pulse train including a first to an N-th chip pulse sequentially arranged on a time axis to output the chip pulse train,
said i-th unit FBG arranged so as to give a relative phase equal to 2Π[b+(m/N)]*(i−1) with respect to the first chip pulse, where m is an integer from 0 to (N−1), inclusive, and b is a parameter of real number satisfying 0≧b<1,
the unit segment length representing the distance between said i-th unit FBG and said (i+1)-th unit FBG.

4. The device as claimed in claim 3, wherein the unit grating length is shorter than 1/2 of the unit segment length.
